(19) United States
(12) Patent Application Publication
(10) Pub. No.: US 2011/0207891 A1
(43) Pub. Date: Aug. 25, 2011

(54) Delayed Curing of Halogenated Elastomers

(76) Inventors: J. Scott Parent, Kingston (CA); Ralph A. Whitney, Kingston (CA)

(21) Appl. No.: 13/016,362

(22) Filed: Jan. 28, 2011

Related U.S. Application Data
(60) Provisional application No. 61/299,394, filed on Jan. 29, 2010.

(51) Int. Cl. C08F 8/30; C08F 236/16; C08F 212/12

(52) U.S. Cl. 525/332.3; 525/333.4; 525/374

(57) ABSTRACT

Nucleophilic substitution reactions of halogenated elastomers and latent curatives are used to produce thermoset derivatives that are easily mixed at conventional compounding temperatures, but cure rapidly at conventional cure temperatures.

### RELATED APPLICATIONS

This application claims the benefit of the filing date of U.S. Provisional Patent Application No. 61/299,394, filed on Jan. 29, 2010, the contents of which are incorporated herein by reference in their entirety.

### FIELD OF THE INVENTION

The present invention relates to curing of halogenated elastomers.

### BACKGROUND OF THE INVENTION

Poly(isobutylene-co-isoprene) (“IIR”) is a synthetic elastomer commonly known as butyl rubber that has been prepared since the 1940's through random cationic copolymerization of isobutylene with small amounts of isoprene (1-2 mole %). Halogenated forms of IIR, which include brominated IIR (“BIIR”) and chlorinated IIR (“CIIR”) cure (or crosslink) more rapidly than unhalogenated forms when treated with standard vulcanization techniques. Similarly, brominated poly(isobutylene-co-methylstyrene) (“BIMS”) is an elastomeric material that, when cured, has good air impermeability and oxidative resistance qualities. The increased reactivity of halogenated IIR is due to the presence of allylic halide functionality, which is susceptible to nucleophilic substitution. Increased reactivity of BIMS is due to the presence of benzylic halide functionality, which is susceptible to nucleophilic substitution. BIMS and BIIR can be cured with sulfur and Lewis acid formulations.

As a result of its molecular structure, IIR possesses superior gas impermeability, excellent thermal stability, good resistance to ozone oxidation, exceptional dampening characteristics, and extended fatigue resistance. In many applications, such elastomers are cross-linked to generate thermoset (cured) articles with greatly improved modulus, creep resistance and tensile properties. Vulcanizing systems usually include sulfur, quinoids, resins, sulfur donors and/or low-sulfur, high-performance vulcanization accelerators. Alternatively, IIR can be halogenated prior to crosslinking to augment its reactivity toward sulfur nucleophiles and toward Lewis acids.

An alternate approach for cross-linking halogenated elastomers involves repeated N-alkylation of primary amines, as illustrated in FIG. 1 (Parent, J. S. et al. Macromolecules 35, 3374-3379, 2002). Given the wide array of available primary amines, this technology can yield thermosets that contain additional chemical reactivity. For example, a cure system with pendant groups such as (MeO)₃SiCH₂CH₂CH₂NH₂ may be useful for elastomeric composites (e.g., BIIR, BIMS). The amine end of (MeO)₃SiCH₂CH₂CH₂NH₂ is available for nucleophilic displacement reactions, and thus becomes bound to the allylic or benzylic carbons while the silicon end of (MeO)₃SiCH₂CH₂CH₂NH₂ is available for binding to silica; for example, advantageously it may bind to Si of siliceous fillers. However, amine alkylation occurs quickly at temperatures that develop during rubber compounding and so there are scorch concerns with elastomers bearing amine pendant groups. Therefore, the practicality of this chemistry would be improved by techniques for controlled (i.e., delayed or selected timing) nucleophile delivery. Thus there is a need for such techniques to control onset of crosslinking halogenated elastomers; therefore, the need exists for latent forms of primary amine nucleophiles that are easily handled, and can be activated when desired.

### SUMMARY OF THE INVENTION

In a first aspect the invention provides a curable elastomeric mixture comprising a halogenated elastomer with substantially no water content; a latent curative having a hydrolytically unstable C═N moiety; and optionally, a moisture-generating component that liberates water when subjected to sufficient heat, wherein the mixture remains uncured until it is subjected to a trigger.

In a second aspect the invention provides a cured polymeric product prepared by subjecting the mixture of claim 1 to a trigger.

In a third aspect the invention provides a process for preparing an elastomeric mixture, comprising mixing a halogenated elastomer having substantially no water content, with a latent curative having a hydrolytically unstable C═N bond, to form an elastomeric mixture that remains uncured until it is subjected to a trigger.

In a fourth aspect the invention provides a process for preparing crosslinked polymer, comprising mixing a halogenated elastomer having substantially no water content, with a latent curative having a hydrolytically unstable C═N bond, to form a mixture; and subjecting the mixture to a trigger.

In a fifth aspect the invention provides a process for preparing crosslinked polymer, comprising subjecting to a trigger a mixture of halogenated elastomer having substantially no water content and a latent curative agent that comprises a hydrolytically unstable C═N moiety.

In a sixth aspect the invention provides a process for crosslinking a halogenated elastomer comprising subjecting to a trigger a mixture of: halogenated elastomer having substantially no water content; a latent curative agent that comprises a hydrolytically unstable C═N moiety; and a moisture-generating component that liberates water when subjected to sufficient heat.

In a seventh aspect the invention provides a kit comprising a halogenated elastomer with substantially no water content; a latent curative having a hydrolytically unstable C═N moiety; and instructions comprising directions to subject a mixture of the halogenated elastomer and the latent curative to moisture to form cross-linked polymer.

In a eighth aspect the invention provides a kit comprising a first container housing wet halogenated elastomer; a second container housing latent curative having a hydrolytically unstable C═N moiety; and instructions comprising directions to mix the halogenated elastomer and the latent curative together to form cross-linked polymer.

In a ninth aspect the invention provides a kit comprising a halogenated elastomer with substantially no water content; a latent curative having a hydrolytically unstable C═N moiety; a moisture-generating component that liberates water when subjected to sufficient heat; and instructions comprising directions to subject a mixture of the halogenated elastomer, latent curative, and moisture-generating component to sufficient heat to liberate moisture from the moisture-generating component to form cross-linked polymer.

In embodiments of all of the above aspects, the trigger is water. In embodiments of all of the above aspects, the trigger is exposure to a humid environment. In embodiments of all of the above aspects, the trigger is adding a compound that includes water. In embodiments of all of the above aspects, the trigger is addition of a hydrolysis catalyst to the mixture. In certain embodiments, the hydrolysis catalyst comprises a carboxylic acid; sulfonic acid; organotitanate; an organometallic compound including carboxylate of lead, cobalt, iron, nickel, zinc and tin; or a combination thereof. Embodiments of all of the above aspects further comprise a moisture-generating component, wherein the trigger is sufficient heat to cause release of water from the moisture-generating component. In certain embodiments of all of the aspects, the latent curative comprises an imine moiety, an amidine moiety, a guanidine moiety, or a C═N moiety attached to a sulphur or oxygen heteroatom.

In embodiments of all of the above aspects, the latent curative comprises a compound of formula (1)

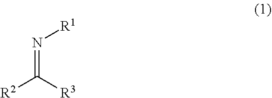

where R¹ is a substituted or unsubstituted C₁ to about C₂₅ alkyl, or a substituted or unsubstituted C₁ to about C₁₋₂ aryl group, wherein substituents may bear a functionality; R² and R³ are independently H, substituted or unsubstituted C₁ to about C₂₋₅ alkyl, or a substituted or unsubstituted C₁ to about C₁₂ aryl group, wherein substituents may bear a functionality; and R¹ and R³ can be independent or can be taken together with the C═N unit to which they are attached, to form a cyclic structure. In certain embodiments the cyclic structure is non-aromatic. In certain embodiments, the compound of formula (1) is N-hexadecyl benzaldimine; N-octyl para-dimethylaminobenzaldimine; or N-hexadecyl methylphenylketimine.

In embodiments of all of the above aspects, the latent curative comprises a compound of formula (2):

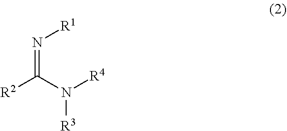

where R¹ is a substituted or unsubstituted C₁ to about C₂₅ alkyl, or a substituted or unsubstituted C₁ to about C₁₂ aryl group, wherein substituents may bear a functionality; R², R³ and R⁴ are independently hydrogen, a substituted or unsubstituted C₁ to about C₂₅ alkyl, or a substituted or unsubstituted C₁ to about C₁₂ aryl group; and R¹ and R³ can be independent or can be taken together with the N—C═N unit to which they are attached, to form a cyclic structure; and R² and R³ can be independent or can be taken together with the C—N unit to which they are attached to form a cyclic structure. In certain embodiments the cyclic structure that includes R¹ and R³ is a non-aromatic. In embodiments of all of the above aspects, the latent curative comprises a compound of formula (3):

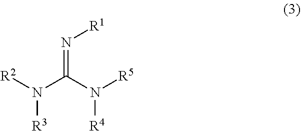

where R¹ is a substituted or unsubstituted C₁ to about C₂₅ alkyl, or a substituted or unsubstituted C₁ to about C₁₂ aryl group, wherein substituents may bear a functionality; R², R³, R⁴, and R⁵ are independently hydrogen, a substituted or unsubstituted C₁ to about C₂₅ alkyl, or a substituted or unsubstituted C₁ to about C₁₂ aryl group; any combination of two of R¹ to R⁵, can be independent or taken together with the N—C═N or N—C—N unit to which they are attached, can form a cyclic structure. In certain embodiments the compound of formula (3) is 1,5,7-triazabicyclo[4.4.0]dec-5-ene.

In embodiments of all of the above aspects, the latent curative comprises a compound of formula (4):

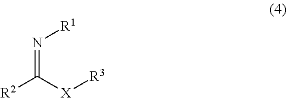

where X is oxygen or sufur; R¹ is a substituted or unsubstituted C₁ to about C₂₅ alkyl, or a substituted or unsubstituted C₁ to about C₁₂ aryl group, wherein substituents may bear a functionality; R² and R³ are independently H, substituted or unsubstituted C₁ to about C₂₅ alkyl, or a substituted or unsubstituted C₁ to about C₁₂ aryl group, wherein substituents may bear a functionality; and any two of R¹ to R³ can be independent or can be taken together with the C═N unit or X—C═N unit to which they are attached, to form a cyclic structure. In certain embodiments, the compound of formula (4) is 2-phenyl oxazoline or thiazoline.

In embodiments of all of the above aspects, one or more substituents are silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkenyl, alkynyl, borane, borate, thiol, thioether, sulfate, sultanate, sulfite, thioester, dithioester, halogen, peroxide, phosphate, phosphonate, phosphine, phosphate, alkyl, or aryl. In embodiments of all of the above aspects, halogenated elastomer comprises allylic halide functionality; benzylic halide functionality; alkyl halide functionality; or a combination thereof. In embodiments of all of the above aspects, the latent curative comprises an imine moiety, an amidine moiety, a guanidine moiety, or a C═N moiety attached to a sulphur or oxygen heteroatom. In embodiments of all of the above aspects, further comprising a filler. In embodiments of all of the above aspects, the filler comprises one or more of carbon black, precipitated silica, clay, glass fibre, polymeric fibre, finely divided minerals, exfoliated clay platelets, sub-micron particles of carbon black, and sub-micron particles of silica. In embodiments of all of the above aspects, halogenated elastomer comprises brominated butyl rubber (BIIR), chlorinated butyl rubber (CIIR), brominated poly(isobutylene-co-methylstyrene) (BIMS), or polychloroprene. In embodiments of all of the above aspects, the optional moisture-generating component, wherein the moisture-generating component comprises: a hydrated compound; aluminum trihydroxide (ATH); a mixture of metal oxide and a carboxylic acid; or any combination thereof. In further embodiments, the hydrated compound comprises CaSO₄.2H₂O (gypsum), MgSO₄.7H₂O, or a combination thereof. In further embodiments, the mixture of a metal oxide and a carboxylic acid comprises ZnO and stearic acid.

Embodiments of the third to sixth aspects further comprise adding to the mixture a moisture-generating component that liberates water when subjected to sufficient heat, wherein the trigger is heating sufficiently to cause release of water from the moisture-generating component.

In embodiments of the sixth to eighth aspects, the instructions comprise printed material, text or symbols provided on an electronic-readable medium, directions to an internet web site, or electronic mail. In embodiments of the sixth to eighth aspects, kits further comprise a molded container suitable for use when curing.

### BRIEF DESCRIPTION OF THE DRAWINGS

For a better understanding of the invention and to show more clearly how it may be carried into effect, reference will now be made by way of example to the accompanying drawings, which illustrate aspects and features according to embodiments of the present invention, and in which:

FIG. 1 is a schematic showing a synthetic methodology used to prepare thermoset derivatives of BIIR by N-alkylation of primary amines.

FIG. 2 shows the evolution of storage modulus (G′) of BIIR+C₁₆H₃₃NH₂ and BIIR+PhCHNR¹ formulations containing 1.3 eq. of curative and varying amounts of CaSO₄.2H₂O, where R¹ is n-hexadecyl (n-C₁₆H₃₃), and Ph is phenyl.

FIGS. 3A and 3B illustrate the effect of imine substituents on BIIR cure dynamics and yields for trials of 1.3 eq nucleophile as shown and 1.3 eq CaSO₄.2H₂O, where R¹ is n-hexadecyl (n-C₁₆H₃₃), and Ph is phenyl.

FIG. 4 shows cure dynamic evolution and specifically G′ for formulations of BIMS. Three profiles are shown: BIMS with 1.3 eq. of C₁₆H₃₃NH₂ and 1.3 eq CaSO₄.2H₂O; BIMS with 1.3 eq. of hexadecyl benzaldimine and 1.3 eq. CaSO₄.2H₂O; and BIMS with 1.3 eq. of hexadecyl para-dimethylaminobenzaldimine and 1.3 eq. CaSO₄.2H₂O.

FIGS. 5A-C show cure dynamic evolution and specifically G′ for formulations of BIIR. In FIG. 5A, three profiles are shown: BIIR with 1.3 eq. CaSO₄.2H₂O and 1.5 wt % sulphur alone (no added nucleophile) (□); BIIR with 1.3 eq. CaSO₄.2H₂O, 1.5 wt % sulphur, and 0.25 eq. hexadecylamine (◯); and BIIR with 1.3 eq. CaSO₄.2H₂O, 1.5 wt % sulphur, and 0.25 eq. hexadecyl benzaldimine (⋄). In FIG. 5B, three profiles are shown: BIIR with 1.3 eq. CaSO₄.2H₂O and 3.0 wt % ZnO alone (no added nucleophile) (□); BIIR with 1.3 eq. CaSO₄.2H₂O, 3.0 wt % ZnO, and 0.25 eq. hexadecylamine (◯); and BIIR with 1.3 eq. CaSO₄.2H₂O, 3.0 wt % ZnO, and 0.25 eq. hexadecyl benzaldimine (⋄). In FIG. 5C, three profiles are shown: BIIR with 1.3 eq. CaSO₄.2H₂O, 1.5 wt % sulphur and 3.0 wt % ZnO (no added nucleophile) (□); BIIR with 1.3 eq CaSO₄.2H₂O, 1.5 wt % sulphur, 3.0 wt % ZnO and 0.25 eq. hexadecylamine (◯); and BIIR with 1.3 eq. CaSO₄.2H₂O, 1.5 wt % sulphur, 3.0 wt % ZnO, and 0.25 eq. hexadecyl benzaldimine (⋄).

FIG. 6 shows BIIR cure dynamics evolution of storage modulus (G′) of BIIR with C₁₆H₃₃NH₂ and mixtures of BIIR, 1.3 eq. of specified N-nucleophile curative, and 1.3 eq CaSO₄.2H₂O.

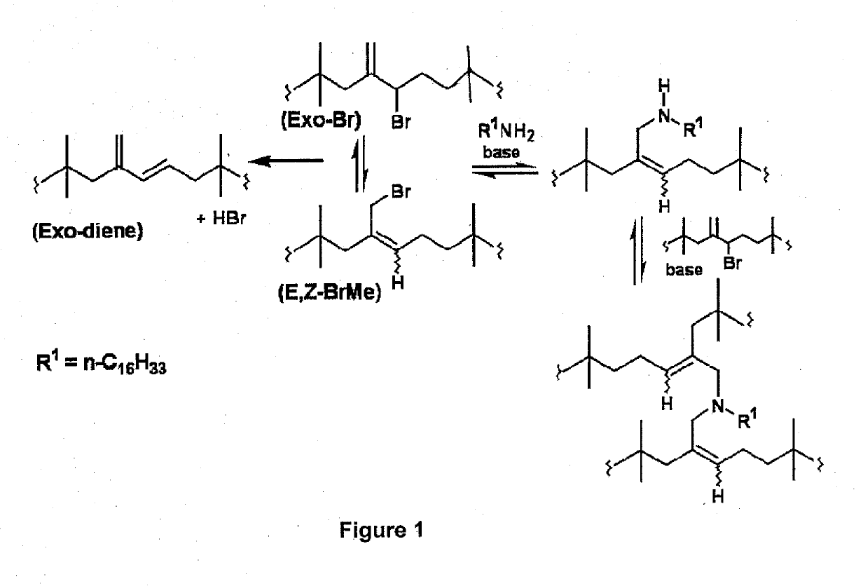

### DETAILED DESCRIPTION OF THE INVENTION

Aspects of the present invention include products that are stable uncured mixtures of halogenated elastomers and latent curatives, that will not cure until triggered to do so. Methods of curing such products are also described in detail below. Briefly, nucleophilic substitution reactions of halogenated elastomers and N-nucleophiles (e.g., amines) are used to produce thermoset derivatives. Examples are provided wherein samples are easily mixed at conventional compounding temperatures, but cure rapidly at conventional cure temperatures. The following terms will be used in the description of these aspects.

### DEFINITIONS

As used herein, the term “latent curative” is a compound that has the potential to initiate crosslinking of certain elastomers but which does not do so unless activated by a trigger. Examples of latent curatives described herein include compounds with a general structure R¹R²C═N—R³ whose C═N bond is susceptible to hydrolysis reactions in the presence of water.

As used herein, the term “IIR” means poly(isobutylene-co-isoprene), which is a synthetic elastomer commonly known as butyl rubber. As used herein, the term “BIIR” means brominated butyl rubber. As used herein, the term “CIIR” means chlorinated butyl rubber.

As used herein, the term “BIMS” means brominated poly(isobutylene-co-methylstyrene).

As used herein, the term “halogenated elastomer” means a polymer, which includes a halogen, that is reactive toward nitrogen nucleophiles.

As used herein, the terms “curing”, “vulcanizing”, and “cross-linking” are used interchangeably and refer to formation of covalent bonds that link one polymer chain to another thereby altering the properties of the material.

As used herein, the term “nucleophilic substitution” refers to displacement of a halide by a nucleophilic reagent and includes N-alkylation of imines, amines and the like.

As used herein, the term “moisture-generating component” is a compound that releases water upon heating and, although the released water participates in reactions, the remainder of the moisture-generating component is either non-reactive or does not inhibit reactions that lead to crosslinks between polymers.

A “trigger” is a change of conditions (e.g., introduction of water, change in temperature) that begins a chemical reaction or a series of chemical reactions.

As used herein “substituted” refers to a structure having one or more substituents. A substituent is an atom or group of bonded atoms that can be considered to have replaced one or more hydrogen atoms attached to a parent molecular entity. For the purpose of the present invention, such atom or group should not inhibit a desired reaction. A substituent can be further substituted. In preferred embodiments, substituents are selected to perform a function.

As used herein, the term “functionality” is a chemical moiety that is not nucleophilic and does not react with allylic carbon or benzyllic carbon, but rather performs a function. For example, a pendant group on an elastomer that includes a Si moiety performs the function of binding to siliceous fillers. Non-limiting examples of functionalities include: silane, alkoxysilane, siloxane, alcohol, epoxide, ether, carbonyl, carboxylic acid, carboxylate, aldehyde, ester, anhydride, carbonate, tertiary amine, amide, carbamate, urea, maleimide, nitrile, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, and aryl.

As used herein, the term “N-nucleophile” refers to a compound comprising nitrogen bearing a lone pair of electrons that undergoes a nucleophilic substitution reaction at an electrophilic site. This may occur, for example, at an allylic or benzyllic site of a halogenated elastomer.

### DESCRIPTION

As discussed above, using previously known technology, it was not possible to adequately control the rate at which halogenated elastomers were cured when they were in the presence of an N-nucleophile (e.g., amine).

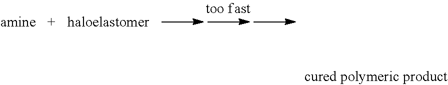

Surprisingly, it has been discovered that control of the cure rate of halogenated elastomers is attained by replacing the N-nucleophile with a latent curative. More specifically, by replacing the N-nucleophile with a N-nucleophile hydrolytic precursor. Formation of cured polymeric product is then delayed by adding a reaction step. Specifically, hydrolysis of an N-nucleophile precursor is required to form the N-nucleophile, which then proceeds to react with the haloelastomer and form crosslinks. Since hydrolysis is needed to activate a latent curative, this method does not suffer from the scorch problems incurred when using a non-latent N-nucleophile.

In the following description, halogenated elastomers of the invention, latent curatives of the invention, triggers, other additives, method of preparing and methods of curing mixtures of the invention are described.

### Halogenated Elastomer

“Halogenated elastomer” as used herein includes mers that are unreactive with the latent curative described herein, and halogen-comprising electrophiles that are also unreactive with the latent curative, but that react with nitrogen nucleophiles. The unreactive mer composition within a halogenated elastomer is not particularly restricted, and may comprise any polymerized olefin monomer. As used herein, the term “olefin monomer” is intended to have a broad meaning and encompasses α-olefin monomers, diolefin monomers and polymerizable monomers comprising at least one olefin linkage.

In certain embodiments, the olefin monomer is an α-olefin monomer. α-Olefin monomers are well known in the art and the choice thereof for use in the present process is within the purview of a person skilled in the art. Preferably, α-olefin monomers of the invention include isobutylene, ethylene, propylene, 1-butene, 1-pentene, 1-hexene, 1-octene, and branched isomers thereof. Other preferred α-olefin monomers of the invention include styrene, α-methylstyrene, para-methylstyrene, and combinations thereof. Particularly preferred α-olefin monomers include isobutylene and para-methylstyrene.

In other embodiments, the olefin monomer comprises a diolefin monomer. Diolefin monomers are well known in the art and the choice thereof for use in the present process is within the purview of a person skilled in the art. Non limiting examples of suitable diolefin monomers include: 1,3-butadiene; isoprene; divinyl benzene; 2-chloro-1,3-butadiene; 2,3-dimethyl-1,3-butadiene; 2-ethyl-1,3-butadiene; piperylene; myrcene; allene; 1,2-butadiene; 1,4,9-decatriene; 1,4-hexadiene; 1,6-octadiene; 1,5-hexadiene; 4-methyl-1,4-hexadiene; 5-methyl-1,4-hexadiene; 7-methyl-1,6-octadiene; phenylbutadiene; pentadiene; and combinations thereof. In another embodiment, the diolefin monomer is an alicyclic compound. Non-limiting examples of suitable alicyclic compounds include: norbornadiene and alkyl derivatives thereof; 5-alkylidene-2-norbornene; 5-alkenyl-2-norbornene; 5-methylene-2-norbornene; 5-ethylidene-2-norbornene; 5-propenyl-2-norbornene; 1,4-cyclohexadiene; 1,5-cyclooctadiene; 1,5-cyclododecadiene; methyltetrahydroindene; dicyclopentadiene; bicyclo[2.2.1]hepta-2,5-diene; and combinations thereof. Preferred diolefin monomers include isoprene and 2-chloro-1,3-butadiene. Of course it is possible to utilize mixtures of the various types of olefin monomers described hereinabove.

In an embodiment, the olefin is a mixture of isobutylene and at least one diolefin monomer. A preferred such monomer mixture comprises isobutylene and isoprene. In this embodiment, it is preferred to incorporate into the preferred mixture of isobutylene and isoprene from about 0.5 to about 3, more preferably from about 1 to about 2 mole percent of the diolefin monomer.

In an embodiment, the olefin is a mixture of isobutylene and at least one α-olefin. A preferred such monomer mixture comprises isobutylene and para-methylstyrene. In this embodiment, it is preferred to incorporate into the mixture of isobutylene and para-methylstyrene from about 0.5 to about 3, more preferably from about 1 to about 2 mole percent of the α-olefin monomer.

As one of skill in the art of the invention will recognize, the number of halogen-containing electrophilic groups per polymer chain will affect the extent of cross-linking that can be achieved by reaction with a triggered latent curative. Typically, the electrophile content of a halogenated elastomer is from about 0.1 to about 100 groups per 1000 polymer backbone carbons. In some cases, electrophile content is between 5 and 50 groups per 1000 polymer backbone carbons.

Selection of a halogenated electrophile is within the purview of a person skilled in the art, and can be made from a group consisting of alkyl halide, allylic halide and benzylic halide, and combinations thereof. Non-limiting, generic structures for these examples are illustrated below, where X represents a halo group and R¹-R⁵ are aliphatic.

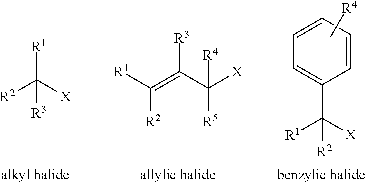

In another embodiment, a halogenated elastomer is comprised of a random distribution of isobutylene mers, isoprene mers and allylic halide electrophiles

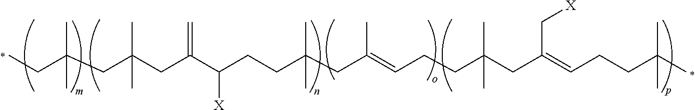

where X is a halo group where preferred halogens include bromine and chlorine, and combinations thereof. Elastomers comprised of about 97 mole % isobutylene, 1 mole % isoprene, and 2 mole % allylic halide are commonly known as halogenated butyl rubber.

In a preferred embodiment, the halogenated elastomer is comprised of a random distribution of isobutylene mers, para-methylstyrene mers and a benzylic halide electrophile

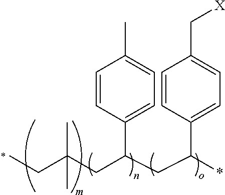

where X is a halo group where preferred halogens include bromine and chlorine, and combinations thereof. Elastomers comprised of about 97 mole % isobutylene, 1 mole % para-methylstyrene, and 2 mole % benzylic bromide are commonly known as BIMS.

In an embodiment, the halogenated elastomer is comprised of a random distribution of 2-chloro-1,3-butadiene mers and an allylic halide electrophile.

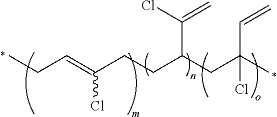

This elastomer is commonly known as polychloroprene.

Preferably the halogenated elastomers used in the present invention have a molecular weight (Mn) in the range from about 10,000 to about 500,000, more preferably from about 10,000 to about 200,000, even more preferably from about 20,000 to about 100,000. It will be understood by those of skill in the art that reference to molecular weight refers to a population of polymer molecules and not necessarily to a single or particular polymer molecule.

### Latent Curatives

In certain embodiments of the invention, the latent curative is a compound of formula (1) shown below which includes an imine moiety:

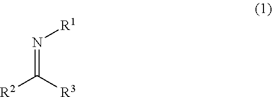

where R¹ is a substituted or unsubstituted C₁ to about C₂₅ alkyl, or a substituted or unsubstituted C₁ to about C₁₂ aryl group, wherein substituents may bear a functionality;

R² and R³ are independently H, substituted or unsubstituted C₁ to about C₂₅ alkyl, or a substituted or unsubstituted C₁ to about C₁₂ aryl group, wherein substituents may bear a functionality; and

R¹ and R³ can be independent or can be taken together with the C═N unit to which they are attached, to form a cyclic structure. In some embodiments, the cyclic structure is non-aromatic. Non-limiting examples of compounds of formula (1) include: N-hexadecyl benzaldimine, N-octyl para-dimethylaminobenzaldimine, and N-hexadecyl methylphenylketimine, whose structures are illustrated below, respectively:

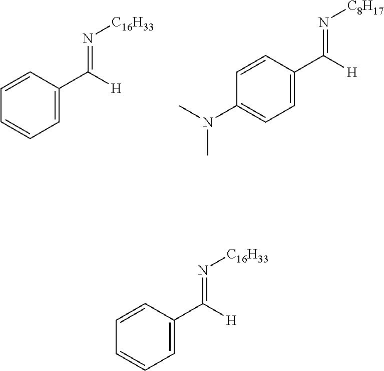

In an embodiment of the invention, the latent curative is a compound of formula (2) shown below that includes an amidine moiety.

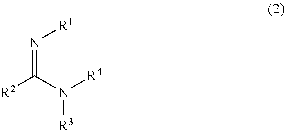

where R¹ is a substituted or unsubstituted C₁ to about C₂₅ alkyl, or a substituted or unsubstituted C₁ to about C₁₂ aryl group, wherein substituents may bear a functionality;

R², R³ and R⁴ are independently hydrogen, a substituted or unsubstituted C₁ to about C₂₅ alkyl, or a substituted or unsubstituted C₁ to about C₁₂ aryl group; and

R¹ and R³ can be independent or can be taken together with the N—C═N unit to which they are attached, to form a cyclic structure; and

R² and R³ can be independent or can be taken together with the C—N unit to which they are attached, can form a cyclic structure. In some embodiments, the cyclic structure of R¹ and R³ is non-aromatic. In some embodiments, the cyclic structure of R² and R³ is non-aromatic.

In an embodiment of the invention, the latent curative is a compound of formula (3) shown below, which includes a guanidine moiety:

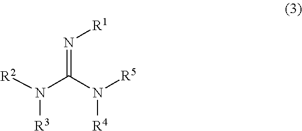

where R¹ is a substituted or unsubstituted C₁ to about C₂₅ alkyl, or a substituted or unsubstituted C₁ to about C₁₂ aryl group, wherein substituents may bear a functionality; R², R³, R⁴, and R⁵ are are independently hydrogen, a substituted or unsubstituted C₁ to about C₁₂ alkyl, or a substituted or unsubstituted C₁ to about C₁₋₂ aryl group. Any combination of two of R¹ to R⁵, such as R¹ and R³ can be independent or taken together with the N—C═N or N—C—N unit to which they are attached, can form a cyclic structure. In some embodiments, the cyclic structure is non-aromatic. A non-limiting example of a compound of formula (3) includes 1,5,7-triazabicyclo[4.4.0]dec-5-ene, whose structure is illustrated below.

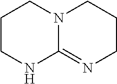

In one embodiment, the invention involves a latent curative that contains a sulphur or oxygen heteroatom.

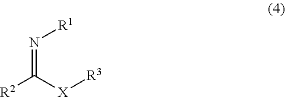

where R¹ to R³ are as defined above and X is oxygen (O) or sufur (S). Non-limiting examples of compounds of formula (4) include: 2-phenyl oxazoline, and thiazoline, whose structures are shown below, respectively:

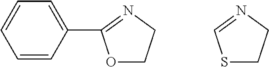

### Amount of Latent Curative

Given that crosslinking involves nucleophilic displacement of halogen from the halogenated elastomer, the amount of latent curative used relative to the amount of halogen affects the extent of polymer crosslinking. Typically, the molar ratio of latent curative to halogen is from about 0.1:1 to about 3.0:1. More preferably, the molar ratio of latent curative to halogen is from about 0.7:1 to about 1.5:1.

### Triggers

A mixture of halogenated elastomer as described above and moisture sensitive latent curative also as described above, are able to remain stably un-crosslinked until they are activated by a trigger. As shown in the working examples and figures, the inventors have shown that controlled delayed onset of curing was achieved. Several examples of mixtures of latent curatives and halogenated elastomers were studied. In some embodiments, such a mixture comprised latent curative and halogenated elastomers and the trigger was exposure to moisture.

The term “moisture” means an amount of water sufficient to initiate and sustain such crosslinking reactions. Moisture may be provided from a number of sources and providing moisture includes adding actual water, adding an unreactive compound that includes water, adding components that liberate water through reaction, heat, etc. In some embodiments, the halogenated elastomers are sufficiently wet to act as both the halogenated elastomer and the moisture-generating component since some halogenated elastomers include water when they are received from the manufacturer. In these cases, rigorous exclusion of water while mixing polymer+latent nucleophile formulation is necessary to ensure that crosslinking does not occur during the mixing process or during storage.

In some cases, moisture can be provided merely by passively exposing the mixture to a humid atmosphere; this type of formulation could be used, for example, in moisture-curing sealant applications. In such applications, a user applies a sealant to a surface and exposure to natural humidity in the atmosphere is sufficient to activate the latent curative. In such applications, substituents bearing a functionality may include antibacterial and/or antifungal properties.

In some embodiments, a moisture-generating component was added to the mixture of latent curative and halogenated elastomers. Advantageously, moisture-generating components are compounds that either include molecules of water that are reliably liberated at specific temperatures or that react to form water at certain temperatures. In these embodiments, a trigger to activate the latent nucleophile is heat. Heating the mixture at a sufficient temperature to cause liberation of water from the moisture-generating component will enable hydrolysis of the latent curative, and will start the crosslinking process.

For this reason, dry halogenated elastomer is preferred for allowing delayed and controlled initiation of crosslinking. Nonlimiting examples of moisture-generating components include chemical compounds that have waters of hydration (also known as waters of crystallization), such as CaSO₄.2H₂O and MgSO₄.7H₂O. Other moisture-generating components include aluminum trihydroxide (ATH), and mixtures of metal oxides and carboxylic acids (e.g., ZnO and stearic acid). Typically, the molar ratio of water to latent curative is from about 0.5:1 to about 5.0:1. More preferably, the molar ratio of water to latent curative is from about 1:1 to about 3:1.

### Other Additives

In many applications it is desirable to use a relatively small amount of a functional amine such as (MeO)₃SiCH₂CH₂CH₂NH₂ in conjunction with standard sulfur and/or ZnO based curative systems. In these cases, reaction of the amine with the halogenated elastomer is intended to introduce additional chemical functionality to the polymer, while the standard cure formulation is designed to generate the requisite degree of crosslinking. However, as discussed previously, the reactivity of amines leads to scorch problems, even when used in small amounts. A latent form of a primary amine such as the latent curatives described herein allow this class of functional nucleophiles to be used as additives without concern for premature crosslinking. In an embodiment of the invention, halogenated elastomer, latent curative, and a conventional sulfur-based curative are mixed at a temperature below that which supports hydrolysis of the latent curative. The resulting mixture is optionally stored, formed into the desired shape, and heated to hydrolyze the latent curative and crosslink the halogenated elastomer by reaction of the N-nucleophile, sulfur and other cure formulation components.

In some embodiments, a hydrolysis catalyst promotes conversion of a latent curative to a reactive nucleophile, and increases the rate of halogenated elastomer crosslinking. Nonlimiting examples of hydrolysis catalysts include carboxylic acids; sulfonic acids; an organometallic compound including an organic titanates; an organometallic compound including complexes or carboxylates of lead, cobalt, iron, nickel, zinc and tin; or any combination thereof. A sufficient amount of hydrolysis catalyst is a catalytic amount, for example, from about 50 ppm to about 10,000 ppm, or from about 100 ppm to about 5000 ppm.

In some embodiments, a filler is added to the mixture of haloelatomer and latent curative to improve the physical properties of polymers. Provision of a filler such as carbon black, precipitated silica, clay, glass fibres, polymeric fibres and finely divided minerals. Typically, the amount of filler is between 10 wt % and 60 wt %. Preferably, filler content is between 25 and 45 wt %.

Provision of a nano-scale fillers such as exfoliated clay platelets, sub-micron particles of carbon black, or sub-micron particles of mineral fillers such as silica can improve the physical properties of polymers, in particular the impermeability and stiffness of the material. Typically, the amount of nano-scale filler is between 0.5 wt % and 30 wt %. Preferably, nano-scale filler content is between 2 and 10 wt %.

### Method of Preparing Mixture of Haloelastomer and Latent Additive

In some embodiments described herein, haloelastomer should be scrupulously dried prior to mixing with latent curative. Drying techniques may include placing under reduced pressure, heating, and/or mixing one or more desiccant materials (such as, for example, activated molecular sieves) into the haloelastomer. To maintain the dryness, exposure to a humid environment after drying should be avoided. In other embodiments undried haloelastomer was mixed with latent curative.

As described more thoroughly in the working examples, samples of haloelastomer and latent additive can be effectively mixed using equipment suited to mix elastomeric material. For example, as described in the working examples a Working Exam Haake Rheomix 600 batch mixing bowl with temperature control, set at a suitable temperature, and equipped with Banbury blades at 60 rpm was used (see Example 1 where 50° C. for 10 min was used).

In certain embodiments described herein, additives are also added to the mixture of haloelastomers and latent curatives, such as moisture-generating component (e.g., gypsum) hydrolysis catalyst, and/or filler. Such additives can be added prior to mixing the haloelastomer and latent curative, or two of the three component can be mixed and then the third component mixed into the mixture of the first two. Mixing should continue until the mixture is thoroughly blended together.

### Method of Curing

In certain embodiments, the halogenated elastomer and latent curative are mixed with the rigorous exclusion of water. The mixture can then be stored and/or transported. When desired, the resulting mixture is formed or molded into the desired shape, and subsequently subjected to a trigger, which may be exposure to moisture, with or without the application of heat, to hydrolyze the latent curative and crosslink the halogenated elastomer.

In an embodiment of the invention, halogenated elastomer is mixed with latent curative and a moisture-generating component at a mixing temperature that is too low to cause liberation of water from the moisture-generating component so that hydrolysis of the latent curative does not occur. Thus, cross-linking does not occur during the mixing process. A stable uncured mixture is provided that can be stored at sufficiently low temperatures to ensure that water is not liberated by the moisture-generating component. The resulting mixture can be formed or molded into the desired shape, and then cured. In such embodiments, curing is conveniently possible by heating the mixture at a temperature sufficient to liberate water from the moisture-generating component, which causes hydrolysis of the latent curative, which generates amine nucleophiles, which react with the halogenated electrophiles of the elastomers, resulting in cured polymeric product.

As described in the following working examples, latent curatives were prepared and characterized by NMR spectroscopy. In studies described herein, these latent curatives were mixed with halogenated elastomers and upon activation by a trigger were successful in crosslinking halogenated elastomers in the absence and presence of fillers and in the absence and presence of carbon black and silica. Accordingly, cured articles were prepared as described below. Such cured articles are reasonably expected to have superior qualities such as good thermo-oxidative stability, exceptional compression set resistance, high modulus, and excellent gas impermeability. Accordingly, articles made from such crosslinked halogenated elastomers such as, for example, tire inner liners, gaskets, and sealants, can benefit from these qualities.

Whereas the dynamics of simple bromide displacements typically follow bimolecular substitution kinetics, as shown in the figures and described in the following working examples, a controllable nucleophile provides tailored cure dynamics such that standard mixing operations can be used without scorch concerns. The following working examples further illustrate the present invention and are not intended to be limiting in any respect.

Aspects of the present invention may be supplied as a kit. In an embodiment of this aspect, the kit includes haloelastomer and latent curative that is provided as a mixture that is stored in a single container; there should be substantially no water in the mixture. The single container should be such that the integrity of its contents is preserved. The user of the kit would then apply the mixture to a surface (or form a desired shape) and add water. As described above, adding water may include passively allowing a humid atmosphere to be in contact with the mixture.

In another embodiment of this aspect, the kit includes haloelastomer and latent curative that are stored in two separate containers. One of the two containers stores haloelastomer and the second container stores latent curative. Optionally, the haloelastomer can include water (e.g., wet haloelastomer). If water is included in the haloelastomer, then the user merely mixes the two components together and the mixture cures due to the presence of water from the haloelastomer container being in contact with the latent curative. If the haloelastomer container does not include water, but instead houses dry haloelastomer, then the user would mix the two components, apply to a surface (or form a desired shape) and add water. As described above, adding water may include passively allowing a humid atmosphere to be in contact with the mixture.

In another embodiment of this aspect, the kit includes haloelastomer, latent curative, and moisture-generating component. If there is substantially no water included then the mixture may be conveniently provided in a single container. Alternatively, the kit components may be provided in separate containers, keeping in mind that the moisture-generating component could be housed with the haloelastomer at any temperature and it could be housed with the latent curative at temperature below that which causes liberation of water from the moisture-generating curative. In a kit which includes the moisture-generating component, the user applies a mixture of the three components to a surface (or form a desired shape) and heats it to a sufficient temperature to liberate moisture from the moisture-generating component.

For example, suitable containers include simple bottles that may be fabricated from glass, organic polymers such as polycarbonate, polystyrene, etc., ceramic, metal or any other material typically employed to hold reagents or food that may include foil-lined interiors, such as aluminum foil or an alloy. Other containers include vials, flasks, and syringes. The containers may have two compartments that are separated by a readily removable membrane that upon removal permits the components to mix. Removable membranes may be glass, plastic, rubber, or the like.

Optionally, kits may also include a molded container to house the mixture during the curing process. Such molds may facilitate preparation of cured polymer in convenient or custom shapes.

Kits may also include instruction materials. Instructions may be printed on paper or other substrates, and/or may be supplied as an electronic-readable medium, such as a floppy disc, CD-ROM, DVD-ROM, Zip disc, videotape, audio tape, etc. Detailed instructions may not be physically associated with the kit; instead, a user may be directed to an internet web site specified by the manufacturer or distributor of the kit, or supplied as electronic mail.

### WORKING EXAMPLES

### Materials and Methods

1-Hexadecylamine (technical grade, 90%), benzaldehyde 99%), acetophenone (99%), benzophenone (≧99%), 4-methoxybenzaldehyde (98%), 4-(dimethylamino)benzaldehyde (99%), 4-cyanobenzaldehyde (95%), 4-nitrobenzaldehyde (98%) and calcium sulfate dihydrate (gypsum, 98%) were used as received from Sigma Aldrich (Oakville, Ont.). BIIR (LANXESS Bromobutyl 2030, allylic bromide content ˜0.2 mmol·g⁻¹) was used as manufactured by LANXESS Inc. (Sarnia, ON, Canada). BIMS (benzylic bromide content ˜0.21 mmol·g⁻¹) was used as manufactured by Exxon Mobil (Houston, Tex., USA).

The extent of crosslinking as a function of time was monitored through measurements of dynamic shear modulus (G′) using an Advanced Polymer Analyzer 2000 (Alpha Technologies, Akron, Ohio, USA) operating at an oscillation frequency of 1 Hz and an arc of 3°.

### Example 1

### Comparison of Cure Dynamics of Haloelastomer+Amine Relative to Haloelastomer+Imine

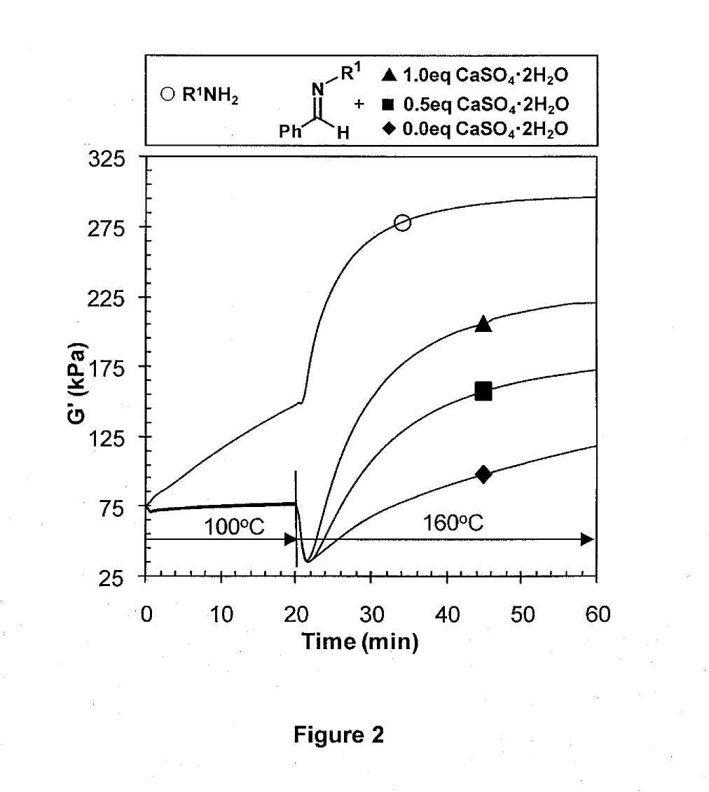

This example illustrates the cure dynamics generated by the direct alkylation of hexadecylamine by BIIR, and the delayed onset cure dynamics provided by the imine analogue, hexadecyl benzaldimine. BIIR (40 g) was mixed with hexadecylamine (2.60 g, 1.3 eq to allylic bromide) in a Haake Rheomix 600 batch mixing bowl equipped with Banbury blades at 60 rpm and 50° C. for 10 min. The rheological data plotted in FIG. 2 show the extensive crosslinking of this mixture at 100° C. The storage modulus (G′) of this mixture increased from 74 kPa to 147 kPa within 20 min at 100° C. Subsequent heating to 160° C. softened the material initially, but then accelerated the cure toward a plateau of 296 kPa.

Benzaldehyde (1.68 g, 0.016 mol) was added drop-wise to 1-hexadecylamine (3.28 g, 0.014 mol) and heated to 110° C. in a Kugelrohr distillation apparatus (17 mmHg) for 5 hours, yielding a yellow-brown liquid, N-hexadecyl benzaldimine. BIIR (40 g) was subsequently mixed with N-hexadecyl benzaldimine (1.3 eq to allylic bromide) as described above. FIG. 2 shows that the storage modulus of this PhCHNR¹ formulation was virtually unchanged over 20 min at 100° C., indicating that substantially no crosslinking was occurring. Subsequent heating to 160° C. generated a modest rate of cure that reached 117 kPa within 40 min. This low cure extent was due, in part, to inadequate moisture within the compound, which was rectified by adding CaSO₄.2H₂O during the compound mixing process. The data plotted in FIG. 2 show that one equivalent of gypsum relative to imine raised the final modulus by a factor of 1.8 to a value of 220 kPa.

### Example 2

### Cure Dynamics of BIIR+Substituted Imines

This example illustrates the effect of imine substituents on the dynamics and yields of BIIR+imine cures. Imines were first synthesized by charging a round-bottom flask with 1-hexadecylamine and adding a slight molar excess of the desired para-substituted benzaldehyde, acetophenone, or benzophenone. Resulting solutions were heated to 115° C. in a Kugelrohr distillation apparatus (17 mmHg) for 6 hours. Each imine was mixed with BIIR and cured in the rheometer as described in Example 1.

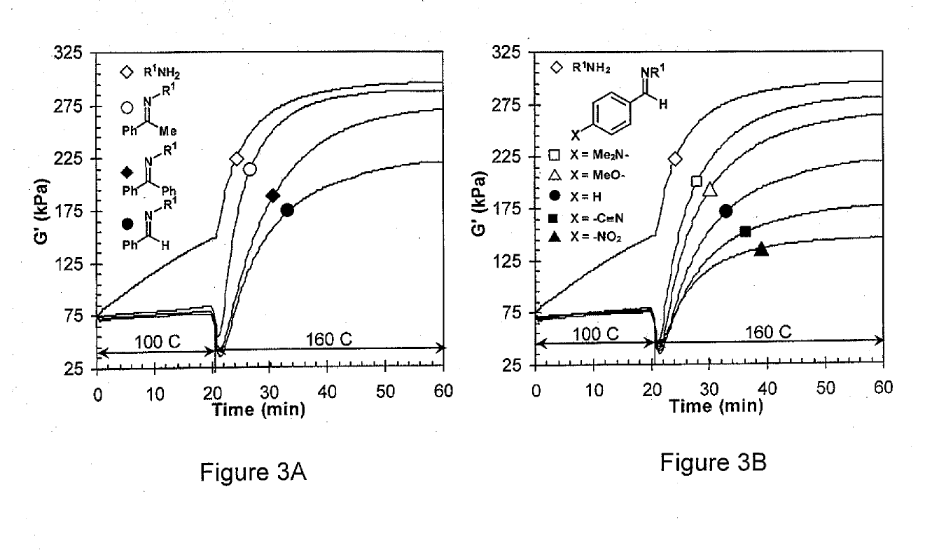

Rheology data is presented in FIGS. 3A and 3B which show that all of imines provided prolonged latency periods at 100° C. When heated to 160° C., the p-NMe₂PhCHNR¹ (where Ph is phenyl and R¹ is n-C₁₆H₃₃) formulation generated a final storage modulus of 281 kPa—just 16 kPa lower than that generated by the free amine. The trends observed for other para-substituents were consistent with expectations, with cure efficiencies following the same order as the Hammett parameters: Me_{2N}>MeO>H>CN>NO₂. Methyl and phenyl substituents on the imine carbon generated similar effects, with the acetophenone-derived imine reaching the same modulus as C₁₆H₃₃NH₂.

### Example 3

### Comparison of Cure Dynamics for BIMS+Amine Versus BIMS+Imine

This example illustrates the cure dynamics generated by the direct alkylation of hexadecylamine by BIMS, and the delayed onset cure dynamics provided by the imine analogues hexadecyl benzaldimine, and hexadecyl para-dimethylaminobenzaldimine.

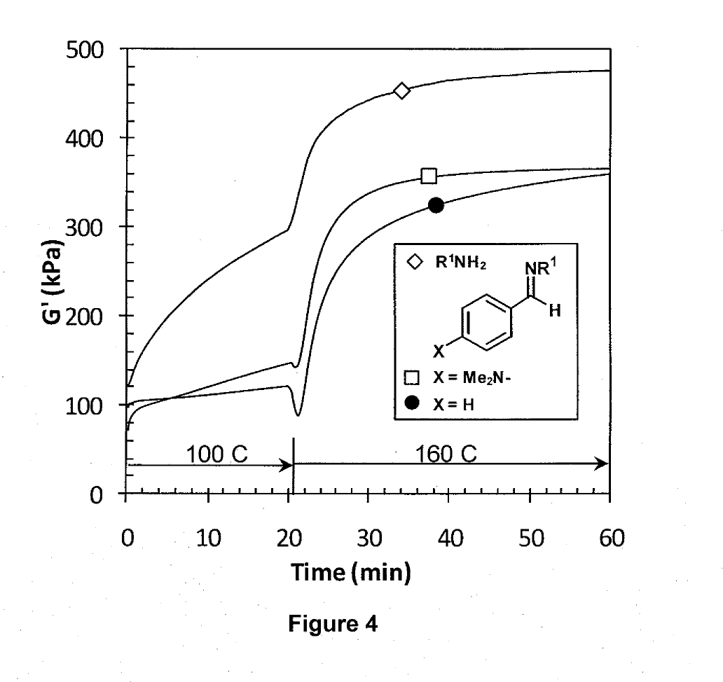

Rheology data presented in FIG. 4 illustrate the high crosslinking reactivity of BIMS when it is compounded with hexadecylamine, as the storage modulus increased from 122 kPa to 306 kPa within 20 minutes at 100° C. When the temperature of this compound was raised to 160° C., the modulus increased further to a value of 476 kPa within 40 minutes. In contrast, the hexadecyl benzaldimine cure formulation showed only a marginal increase in modulus at 100° C., and a high extent of crosslinking after 40 minutes at 160° C., as evidenced by a final G′ value of 359 kPa. Similar performance was observed for hexadecyl para-dimethylaminobenzaldehyde.

### Example 4

### Conventional BIIR Cure Formulations

In some cases, sulphur and/or ZnO chemistry is designed to generate the requisite cross-link density, while a relatively small amount of a functional amine provides additional chemical reactivity. To be effective in such an application, the amine must react with the halogenated elastomer without complicating the compound mixing process or impacting negatively on the cross-link density of the cured article.

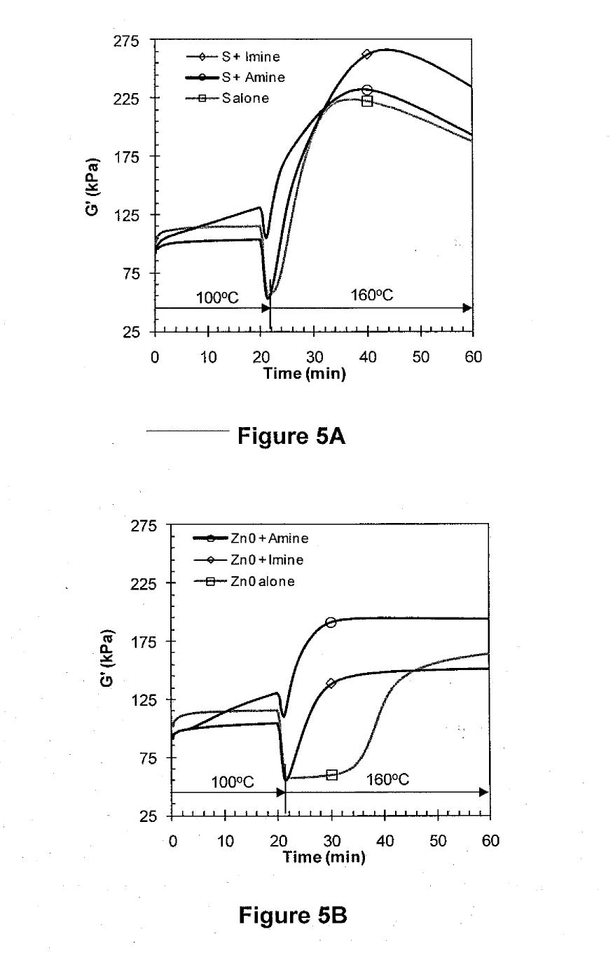

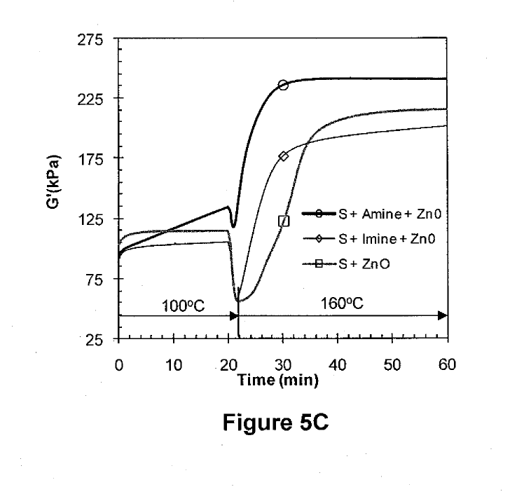

When BIIR was mixed with 0.25 eq of C₁₆H₃₃NH₂ and heated to 100° C. for 20 min, the compound cured to a storage modulus of 128 kPa. The data plotted in FIG. 5 show that this amount of C₁₆H₃₃NH₂ brought the sulphur-only (FIG. 5A), ZnO-only (FIG. 5B), and sulphur+ZnO (FIG. 5C) formulations to the same modulus during the first phase of the 100° C./160° C. step experiment. In contrast, 0.25 eq PhCHNR¹ avoided low temperature scorch problems for any of the sulphur, ZnO, or sulphur+ZnO formulations. Indeed, the modulus of the imine-containing mixtures was lower than the control compounds, owing to the plasticizing effect of a soluble small molecule. Further benefits were realized for all three cure formulations, as the imine raised the ultimate modulus of the sulphur-only system, and reduced the induction periods that are observed for ZnO-only and sulphur+ZnO formulations.

### Example 6

### Performance of Certain Latent Curatives

This example illustrates the cure dynamics provided by latent curatives containing heteroatom substitutents adjacent to the C═N bond. The desired latent curative was mixed with BIIR and cured in the rheometer as described in Example 1.

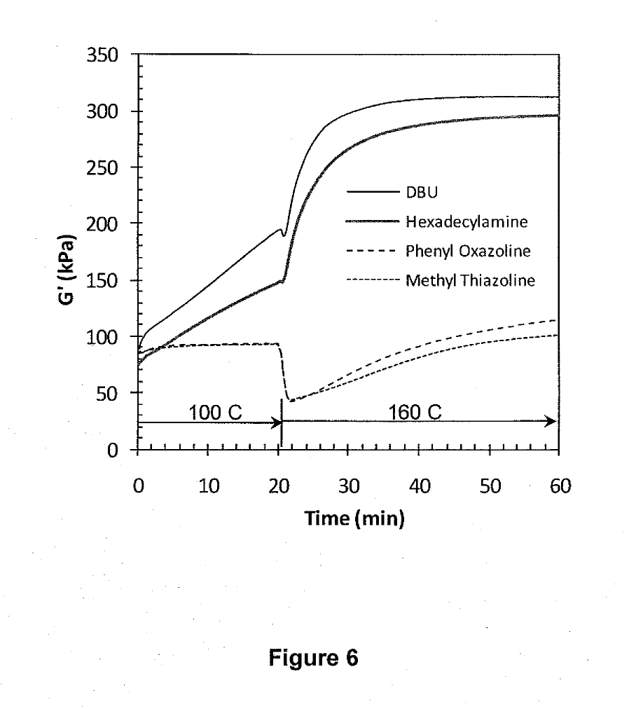

The rheology data illustrated in FIG. 6 demonstrate the stability of BIIR+phenyl oxazoline and BIIR+methyl thiazoline mixtures at 100° C. Subsequent heating of these formulations to 160° C. activated the latent curatives, as evidenced by increases in G′.

The cyclic amidine base, 1,4-diazabicycloundecene (DBU) was more reactive than the primary amine at 100° C., and produced a higher crosslink density than hexadecylamine at 160° C. As such, although this specific amidine is formally a latent curative, its reactivity with respect to halogenated elastomers that contain traces of water is too great as to support a delayed onset cure. Only with the rigorous exclusion of water can a delayed-onset cure process be observed.

It will be understood by those skilled in the art that this description is made with reference to certain embodiments and that it is possible to make other embodiments employing the principles of the invention which fall within its spirit and scope as defined by the claims.

1. A curable elastomeric mixture comprising:
a halogenated elastomer with substantially no water content;
a latent curative having a hydrolytically unstable C═N moiety; and
optionally, a moisture-generating component that liberates water when subjected to sufficient heat,
wherein the mixture remains uncured until it is subjected to a trigger.

2. The curable elastomeric mixture of claim 1, wherein the trigger is water, exposure to a humid environment, or addition of a hydrolysis catalyst to the mixture.

3.-5. (canceled)

6. The curable elastomeric mixture of claim 1, wherein the latent curative comprises a compound of formula (1) 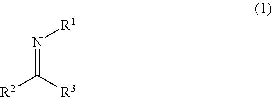
where R¹ is a substituted or unsubstituted C₁ to about C₂₅ alkyl, or a substituted or unsubstituted C₁ to about C₁₂ aryl group, wherein substituents may bear a functionality;
R² and R³ are independently H, substituted or unsubstituted C₁ to about C₂₅ alkyl, or a substituted or unsubstituted C₁ to about C₁₂ aryl group, wherein substituents may bear a functionality; and
R¹ and R³ can be independent or can be taken together with the C═N unit to which they are attached, to form a cyclic structure.

7.-8. (canceled)

9. The curable elastomeric mixture of claim 1, wherein the latent curative comprises a compound of formula (2): 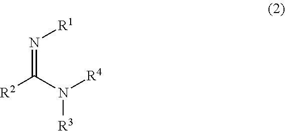
where R¹ is a substituted or unsubstituted C₁ to about C₂₅ alkyl, or a substituted or unsubstituted C₁ to about C₁₂ aryl group, wherein substituents may bear a functionality;
R², R³ and R⁴ are independently hydrogen, a substituted or unsubstituted C₁ to about C₂₅ alkyl, or a substituted or unsubstituted C₁ to about C₁₂ aryl group; and
R¹ and R³ can be independent or can be taken together with the N—C═N unit to which they are attached, to form a cyclic structure; and
R² and R³ can be independent or can be taken together with the C—N unit to which they are attached to form a cyclic structure.

10. (canceled)

11. The curable elastomeric mixture of claim 1, wherein the latent curative comprises a compound of formula (3): 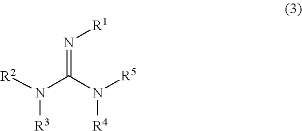
where R¹ is a substituted or unsubstituted C₁ to about C₂₅ alkyl, or a substituted or unsubstituted C₁ to about C₁₂ aryl group, wherein substituents may bear a functionality; R², R³, R⁴, and R⁵ are independently hydrogen, a substituted or unsubstituted C₁ to about C₂₅ alkyl, or a substituted or unsubstituted C₁ to about C₁₋₂ aryl group;
any combination of two of R¹ to R⁵, can be independent or taken together with the N—C═N or N—C—N unit to which they are attached, can form a cyclic structure.

12. (canceled)

13. The curable elastomeric mixture of claim 1, wherein the latent curative comprises a compound of formula (4): 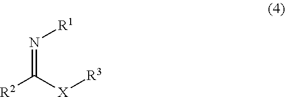
where X is oxygen or sufur;
R¹ is a substituted or unsubstituted C₁ to about C₂₅ alkyl, or a substituted or unsubstituted C₁ to about C₁₂ aryl group, wherein substituents may bear a functionality;
R² and R³ are independently H, substituted or unsubstituted C₁ to about C₂₅ alkyl, or a substituted or unsubstituted C₁ to about C₁₂ aryl group, wherein substituents may bear a functionality; and
any two of R¹ to R³ can be independent or can be taken together with the C═N unit or X—C═N unit to which they are attached, to form a cyclic structure.

14.-22. (canceled)

23. A cured polymeric product prepared by subjecting the mixture of claim 1 to a trigger.

24. The cured polymeric product of claim 23, wherein the trigger is water, exposure to a humid environment, or addition of a hydrolysis catalyst to the mixture.

25.-28. (canceled)

29. The cured polymeric product of claim 23, wherein the latent curative comprises a compound of formula (1) of claim 6, a compound of formula (2) of claim 9, a compound of formula (3) of claim 11, or a compound of formula (4) of claim 13.

30.-37. (canceled)

38. The cured polymeric product of claim 29, wherein one or more substituents are silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, or aryl.

39. The cured polymeric product of claim 23, wherein the latent curative comprises an imine moiety, an amidine moiety, a guanidine moiety, or a C═N moiety attached to a sulphur or oxygen heteroatom.

40.-46. (canceled)

47. A process for preparing an elastomeric mixture, comprising:
mixing a halogenated elastomer having substantially no water content, with a latent curative having a hydrolytically unstable C═N bond, to form an elastomeric mixture that remains uncured until it is subjected to a trigger.

48. (canceled)

49. A process for preparing crosslinked polymer, comprising:
subjecting to a trigger a mixture of halogenated elastomer having substantially no water content and a latent curative agent that comprises a hydrolytically unstable C═N moiety.

50. A process for crosslinking a halogenated elastomer comprising:
subjecting to a trigger a mixture of: halogenated elastomer having substantially no water content; a latent curative agent that comprises a hydrolytically unstable C═N moiety; and a moisture-generating component that liberates water when subjected to sufficient heat.

51. The process of claim 47, wherein the trigger is water, exposure to a humid environment, adding a compound that includes water, or addition of a hydrolysis catalyst to the mixture.

52.-55. (canceled)

56. The process of claim 47, wherein the latent curative comprises a compound of formula (1) of claim 6, a compound of formula (2) of claim 9, a compound of formula (3) of claim 11, or a compound of formula (4) of claim 13.

57.-64. (canceled)

65. The process of claim 56, wherein one or more substituents are silane, alkoxysilane, siloxane, alcohol, epoxide, ether, carbonyl, carboxylic acid, carboxylate, aldehyde, ester, anhydride, carbonate, amine, amide, carbamate, urea, maleimide, nitrile, cyano, olefin, alkenyl, alkynyl, borane, borate, thiol, thioether, sulfate, sulfonate, sulfite, thioester, dithioester, halogen, peroxide, phosphate, phosphonate, phosphine, phosphate, alkyl, or aryl.

66.-74. (canceled)

75. A kit comprising:
a halogenated elastomer with substantially no water content;
a latent curative having a hydrolytically unstable C═N moiety; and
instructions comprising directions to subject a mixture of the halogenated elastomer and the latent curative to moisture to form cross-linked polymer.

76. A kit comprising:
a first container housing wet halogenated elastomer;
a second container housing latent curative having a hydrolytically unstable C═N moiety; and
instructions comprising directions to mix the halogenated elastomer and the latent curative together to form cross-linked polymer.

77. A kit comprising:
a halogenated elastomer with substantially no water content;
a latent curative having a hydrolytically unstable C═N moiety;
a moisture-generating component that liberates water when subjected to sufficient heat; and
instructions comprising directions to subject a mixture of the halogenated elastomer, latent curative, and moisture-generating component to sufficient heat to liberate moisture from the moisture-generating component to form cross-linked polymer.

78. The kit of claim 75, wherein the latent curative comprises a compound of formula (1) of claim 6, a compound of formula (2) of claim 9, a compound of formula (3) of claim 11, or a compound of formula (4) of claim 13.

79.-96. (canceled)
